(19) United States
(12) Patent Application Publication
(10) Pub. No.: US 2026/0126710 A1
(43) Pub. Date: May 7, 2026

(54) MOUNTING STRUCTURE AND PAN-TILT CAMERA

(71) Applicant: Shenzhen Oceanwing Smart Innovations Technology Co., Ltd, SHENZHEN (CN)

(72) Inventor: Keping LIU, SHENZHEN (CN)

(21) Appl. No.: 19/439,044

(22) Filed: Jan. 2, 2026

Related U.S. Application Data
(63) Continuation of application No. PCT/CN2024/103260, filed on Jul. 3, 2024.

(30) Foreign Application Priority Data
Jul. 5, 2023 (CN) 202321749158.X

(51) Int. Cl. G03B 17/56

(52) U.S. Cl. CPC G03B 17/561

(57) ABSTRACT

A mounting structure is configured in a pan-tilt camera, and includes a first mounting portion, a mounting bracket detachably connected to the first mounting part at a first position or a second position, and a locking assembly configured to lock and fix the first mounting portion to the mounting bracket. When the mounting bracket is located at the first position, a second mounting portion is connected to the first mounting portion through a direct insertion, and a mounting end is located at an end of the pan-tilt camera along a first direction. When the mounting bracket is located at the second position, the second mounting portion is connected to the first mounting portion through the direct insertion, the mounting end is located at an end of the pan-tilt camera along a second direction, and an included angle is formed between the first direction and the second direction.

### CROSS-REFERENCE TO RELATED APPLICATIONS

This application is a continuation of International Patent Application No. PCT/CN2024/103260, filed on Jul. 3, 2024, which claims priority to Chinese Patent Application No. 202321749158.X, filed on Jul. 5, 2023, the contents of which are herein incorporated by reference in their entireties.

### TECHNICAL FIELD

The present disclosure relates to the field of camera technology, and in particular to a mounting structure and a pan-tilt camera.

### BACKGROUND

A pan-tilt camera may be a camera provided with a gimbal or pan-tilt head. The pan-tilt camera may include a device that is configured to carry the camera to rotate in both horizontal and vertical directions. Through mounting the camera on the gimbal, the camera may be enabled to perform shooting from multiple angles.

In the related art, an installation manner of the pan-tilt camera may be a fixed installation, and the pan-tilt camera may generally be installed or mounted in a wall-mount manner or a ceiling-mount manner through a mounting bracket. The fixed installation may restrict the mounting and use of the pan-tilt camera, which may be unfavorable for users to flexibly mount and use the pan-tilt camera, and usage scenarios of the users may further be limited. At present, it is still impossible to realize different installation manners on the same pan-tilt camera.

### SUMMARY

In a first aspect of the present disclosure, a mounting structure is provided. The mounting structure is configured in a pan-tilt camera. The mounting structure includes a first mounting portion, a mounting bracket, and a locking assembly. The first mounting portion is disposed on the pan-tilt camera. The mounting bracket is detachably connected to the first mounting portion at a first position or a second position. The mounting bracket includes a second mounting portion and a mounting end. In a case where the mounting bracket is located at the first position, the second mounting portion is connected to the first mounting portion through a direct insertion, and the mounting end is located at an end of the pan-tilt camera along a first direction. In a case where the mounting bracket is located at the second position, the second mounting portion is connected to the first mounting portion through the direct insertion, the mounting end is located at an end of the pan-tilt camera along a second direction, and an included angle is formed between the first direction and the second direction. The locking assembly is disposed between the mounting bracket and the first mounting portion. The locking assembly is configured to lock and fix the first mounting portion to the mounting bracket.

In a second aspect of the present disclosure, a pan-tilt camera is provided. The pan-tilt camera includes a housing and the mounting structure described in the above embodiment. The mounting structure is connected to the housing through the first mounting portion, and the first direction is substantially perpendicular to the second direction.

### BRIEF DESCRIPTION OF THE DRAWINGS

The drawings herein may be incorporated into the present specification and may constitute a part of the present specification, and they may illustrate some embodiments in accordance with the present disclosure and may be used together with the specification to explain the principles of the present disclosure.

In order to illustrate technical solutions of some embodiments of the present disclosure or of the related art more clearly, brief introductions of the drawings required for describing the embodiments or the related art are provided below. It may be apparent to those of ordinary skill in the art that other drawings may also be obtained based on these drawings without creative efforts.

One or more embodiments are illustratively described through the corresponding figures in the accompanying drawings. These illustrative descriptions do not limit the embodiments. Elements in the drawings with the same reference numerals represent similar elements. Unless specifically stated, the figures in the accompanying drawings are not drawn to scale.

FIG. 1 is a schematic structural view of a mounting structure and a pan-tilt camera according to some embodiments of the present disclosure, where a mounting bracket is located at a first position.

FIG. 2 is a schematic structural view of the mounting structure according to some embodiments of the present disclosure, where the mounting bracket is located at a second position.

FIG. 3 is a schematic structural view of the mounting structure according to some embodiment of the present disclosure, where the mounting bracket is located at a pre-mounting position of the second position.

FIG. 4 is a schematic structural view of the mounting bracket of the mounting structure according to some embodiments of the present disclosure, where the mounting bracket is located at the first position.

FIG. 5 is a partial schematic structural view of the mounting structure according to some embodiments of the present disclosure, where a first mounting portion is shown.

FIG. 6 is a schematic structural view of the mounting bracket of the mounting structure according to some embodiment of the present disclosure, where the mounting bracket is located at the second position.

FIG. 7 is a schematic sectional view of the mounting structure according to some embodiments of the present disclosure, where the mounting bracket of the mounting structure is located at the pre-mounting position of the first position.

FIG. 8 is a partial schematic sectional view of the mounting structure in the first position as shown in FIG. 1.

FIG. 9 is a schematic sectional view of the mounting structure according to some embodiment of the present disclosure, where the mounting bracket of the mounting structure is located at a pre-mounting position of the second position.

FIG. 10 is a partial schematic sectional view of the mounting structure in the second position as shown in FIG. 2.

### DETAILED DESCRIPTION

In order to make the above objectives, features, and technical effects of the present disclosure more apparent and easier to understand, detailed descriptions of some embodiments of the present disclosure may be provided below in conjunction with the drawings. Many details may be set forth in the following description to facilitate a full understanding of the present disclosure. However, the present disclosure may be implemented in various manners different from those described herein, and those skilled in the art may make similar modifications without departing from the spirit of the present disclosure. Thus, the present disclosure may not be limited by the embodiments disclosed below.

In the description of the present disclosure, it should be understood that when terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, and the like appear, orientations or positional relationships indicated by these terms may be based on the orientations or positional relationships shown in the drawings, and they may be used merely for facilitating the description of the present disclosure and simplifying the description, rather than indicating or implying that the referenced devices or elements must have a particular orientation or be constructed or operated in a particular orientation. Thus, they may not be construed as limitations to the present disclosure.

In addition, when the terms “first” and “second” appear, such terms may be used merely for descriptive purposes and may not be construed as indicating or implying relative importance or implying the number of the indicated technical features. Thus, features defined by “first” or “second” may explicitly or implicitly include at least one such feature. In the description of the present disclosure, when the term “multiple” or “plurality” appears, “multiple” or “plurality” may mean at least two, for example, two or three, unless otherwise expressly specified.

In the present disclosure, unless otherwise expressly specified or limited, when terms “mounted”, “installed”, “connected”, “coupled”, “fixed”, and the like appear, such terms may be understood in a broad sense. For example, they may refer to fixed connections, detachable connections, or integral formations; they may refer to mechanical connections or electrical connections; they may refer to direct connections or indirect connections through an intermediate medium; they may refer to communication between two components or an interaction relationship between two components, unless otherwise expressly limited. For those of ordinary skill in the art, meanings of the above terms in the present disclosure may be understood based on the particular context.

In the present disclosure, unless otherwise expressly specified or limited, when descriptions such as a first feature being “on” or “under” a second feature appear, the meanings may include that the first and second features are directly in contact, or that the first and second features are indirectly in contact through an intermediate medium. Moreover, the expressions “above”, “upper”, or “on a top of” the second feature may mean that the first feature is directly above or obliquely above the second feature, or may merely indicate that the first feature has a greater vertical height than the second feature. The expressions “beneath”, “lower”, “on a bottom of” or “under” the second feature may mean that the first feature is directly below or obliquely below the second feature, or may merely indicate that the first feature has a smaller vertical height than the second feature.

It should be noted that when an element is described as being “fixed to” or “disposed on” or “arranged on” another element, it may be directly on the other element or may have an intermediate element therebetween. When an element is described as being “connected to” another element, it may be directly connected to the other element or may have an intermediate element simultaneously present. If present, terms such as “vertical”, “horizontal”, “upper”, “lower”, “left”, “right”, and similar expressions used in the present disclosure may be merely for explanatory purposes and may not indicate the unique implementations.

Furthermore, it is to be understood that the use of the term “substantially” herein, unless otherwise defined with respect to a specific context, with respect to a numeric quantity or otherwise quantifiable relationship, e.g., perpendicularity or parallelism, is to be understood as indicating that quantity +−10%. Thus, for example, lines that are substantially perpendicular to one another may be at angles between 81° and 99° to one another. In a further example, dimensions that are substantially between 1 mm and 3 mm, for example, may range from 0.9 mm to 3.3 mm. In another example, an angle that is substantially in the range of 1 to 1.1 radians may be between 0.9 radians and 1.21 radians.

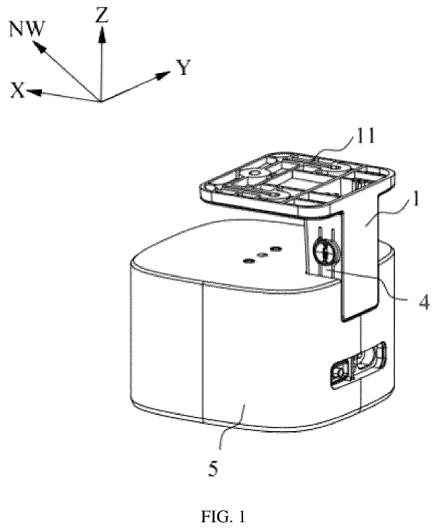

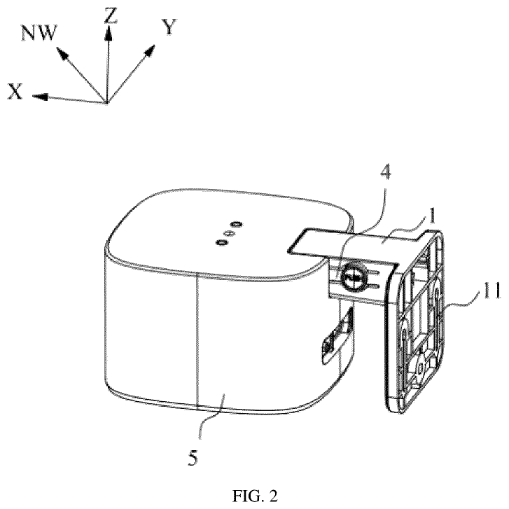

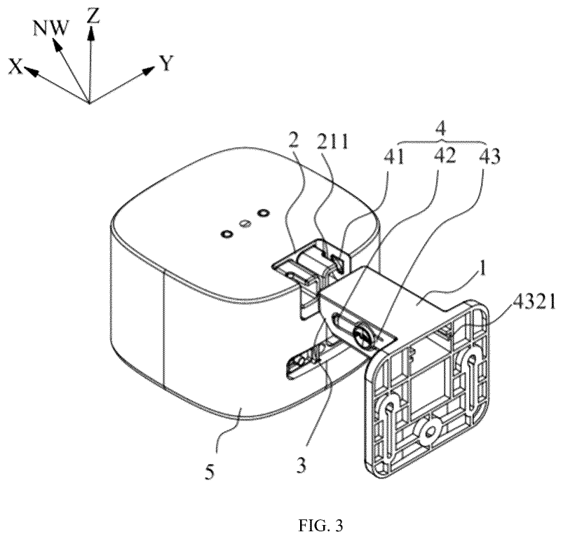

As shown in FIGS. 1-3, FIG. 1 is a schematic structural view of a mounting structure and a pan-tilt camera according to some embodiments of the present disclosure, where a mounting bracket 1 is located at a first position; FIG. 2 is a schematic structural view of the mounting structure according to some embodiments of the present disclosure, where the mounting bracket 1 is located at a second position; and FIG. 3 is a schematic structural view of the mounting structure according to some embodiment of the present disclosure, where the mounting bracket 1 is located at a pre-mounting position of the second position. Some embodiments of the present disclosure provide the mounting structure configured in the pan-tilt camera. The mounting structure includes a first mounting portion 2, the mounting bracket 1, and a locking assembly 4. The mounting bracket 1 is detachably connected to the first mounting portion 2 at the first position or the second position.

In some embodiments, the mounting bracket 1 includes a second mounting portion 3 and a mounting end 11. In a case where the mounting bracket 1 is located at the first position (see FIG. 1), the second mounting portion 3 is connected to the first mounting portion 2 through a direct insertion, and the mounting end 11 is located at an end of the pan-tilt camera along a first direction. In a case where the mounting bracket 1 is located at the second position (see FIG. 2), the second mounting portion 3 is connected to the first mounting portion 2 through the direct insertion, and the mounting end 11 is located at an end of the pan-tilt camera along a second direction. An included angle is formed between the first direction and the second direction. The locking assembly 4 is disposed between the mounting bracket 1 and the first mounting portion 2. The locking assembly 4 is configured to lock and fix the first mounting portion 2 to the mounting bracket 1.

According to the mounting structure of some embodiments of the present disclosure, the first mounting portion 2 and the second mounting portion 3 may be connected to each other through the direct insertion, which provides a guiding installation function and allows for a relatively low requirement for machining accuracy and installation accuracy. In further combination with the locking assembly 4, the mounting structure may enable the pan-tilt camera to achieve different installation manners. The mounting structure may be simple in structure, cost-saving, and easy to install.

As shown in FIG. 1 and FIG. 2, in some embodiments, the first direction may be a Z-direction shown in the figures, that is, a vertical direction. The second direction may be a X-direction shown in the figures, that is, a horizontal direction. In a case where the mounting bracket 1 is in the first position, the mounting end 11 of the mounting bracket 1 may be located at a top of the pan-tilt camera, which enables the mounting end 11 to be mounted or installed at a to-be-mounted position, such as a ceiling and the like, thereby allowing the pan-tilt camera to realize a ceiling-mount configuration. In a case where the mounting bracket 1 is in the second position, the mounting end 11 of the mounting bracket 1 may be located at a side of the pan-tilt camera, which enables the mounting end 11 to be mounted or installed at a to-be-mounted position, such as a wall and the like, thereby allowing the pan-tilt camera to realize a wall-mount configuration.

It may be understood that the first direction and the second direction may each be selected as other directions based on actual installation requirements and characteristics of the actual usage scenarios. The mounting bracket 1 may be configured to have additional predetermined positions. In a case where the mounting bracket 1 is located at different predetermined positions, a position angle of the mounting end 11 relative to the pan-tilt camera may be different. However, regardless of the predetermined position, the first mounting portion 2 and the second mounting portion 3 may be connected to each other through the direct insertion and may be locked and fixed to each other through the locking assembly 4.

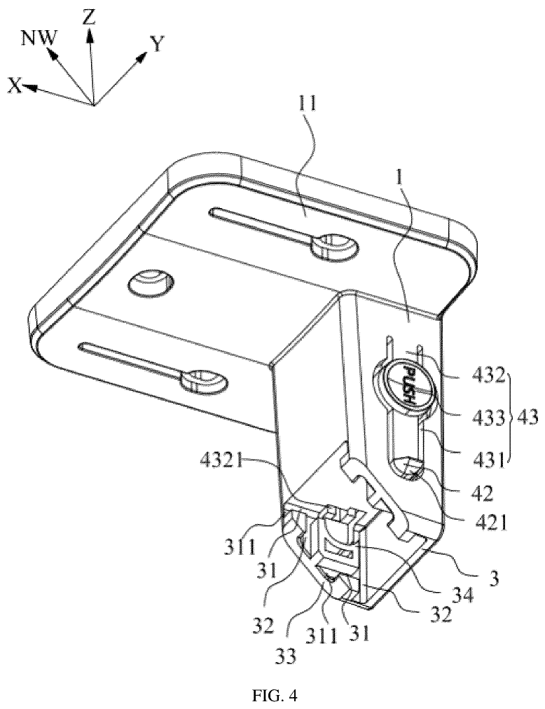

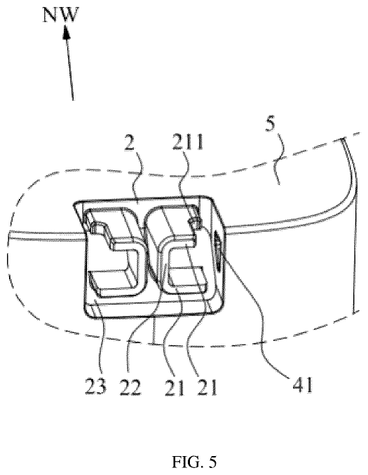

As shown in FIG. 4 and FIG. 5, FIG. 4 is a schematic structural view of the mounting bracket 1 of the mounting structure according to some embodiments of the present disclosure, where the mounting bracket 1 is located at the first position; and FIG. 5 is a partial schematic structural view of the mounting structure according to some embodiments of the present disclosure, where the first mounting portion 2 is shown. In some embodiments, a protrusion 34 may be disposed at an end of the second mounting portion 3 close to the first mounting portion 2. A first slot 31 may be defined on the protrusion 34. A first opening 311 may be defined at an end of the first slot 31. An insertion plate 21 may be disposed at the first mounting portion 2. The insertion plate 21 may be directly inserted into and connected to the first slot 31 through the first opening 311 along the second direction, thereby being connected to the mounting bracket 1 in the first position. In some embodiments, as shown in FIG. 4, in a case where the mounting bracket 1 is in the first position, the first opening 311 may be located at an end of the first slot 31 in the second direction.

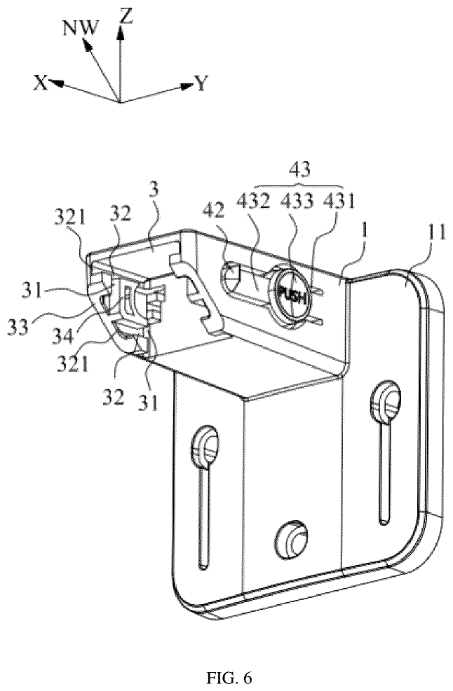

As shown in FIG. 5 and FIG. 6, FIG. 6 is a schematic structural view of the mounting bracket 1 of the mounting structure according to some embodiment of the present disclosure, where the mounting bracket 1 is located at the second position. In some embodiments, a second slot 32 may be defined on the protrusion 34 of the second mounting portion 3. An included angle may be formed between the first slot 31 and the second slot 32. The included angle between the first slot 31 and the second slot 32 may be substantially the same as the included angle between the first direction and the second direction. A second opening 321 may be defined at an end of the second slot 32. The insertion plate 21 may be directly inserted into and connected to the second slot 32 through the second opening 321 along the second direction, thereby being connected to the mounting bracket 1 in the second position. In some embodiments, in a case where the mounting bracket 1 is in the second position, the second opening 321 may be located at an end of the second slot 32 in the second direction. In a case where the mounting bracket 1 is in the first position and the second position, the first mounting portion 2 may be directly inserted into and connected to the second mounting portion 3 along the second direction, i.e., the first mounting portion 2 may be connected to the second mounting portion 3 through the direct insertion along the second direction, thereby providing a convenient and easy connection.

In some embodiments, as shown in FIG. 4, in a case where the mounting bracket 1 is in the first position, the first slot 31 may be defined on a side wall of the protrusion 34 along the second direction, and the second slot 32 may be defined on a side wall of the protrusion 34 along the first direction. As shown in FIG. 6, in a case where the mounting bracket 1 is in the second position, the first slot 31 may be defined on the side wall of the protrusion 34 along the first direction, and the second slot 32 may be defined on the side wall of the protrusion 34 along the second direction. It may be understood that, in some embodiments, in a case where the first direction and the second direction are substantially perpendicular to each other, the first slot 31 and the second slot 32 may be substantially perpendicular to each other.

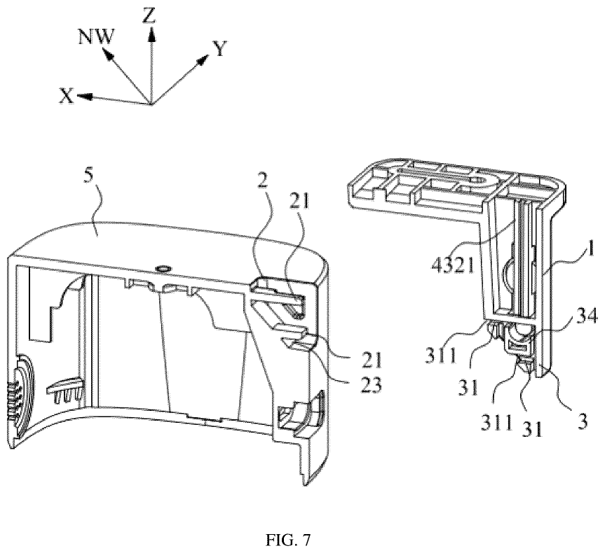

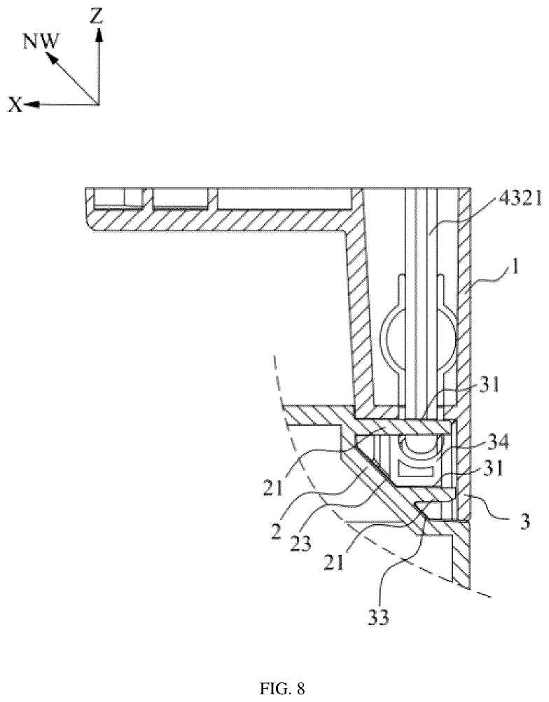

In some embodiments, as shown in FIG. 7 and FIG. 8, FIG. 7 is a schematic sectional view of the mounting structure according to some embodiments of the present disclosure, where the mounting bracket 1 of the mounting structure is located at the pre-mounting position of the first position; and FIG. 8 is a partial schematic sectional view of the mounting structure in the first position as shown in FIG. 1. The insertion plate 21 may be directly inserted into and connected to the first slot 31 through the first opening 311, thereby being connected to the mounting bracket 1 in the first position.

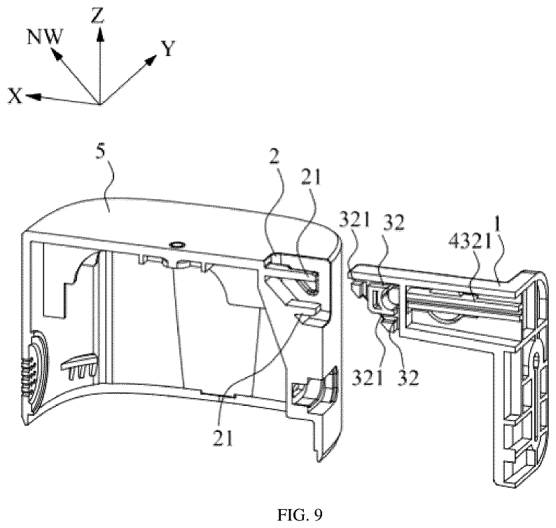

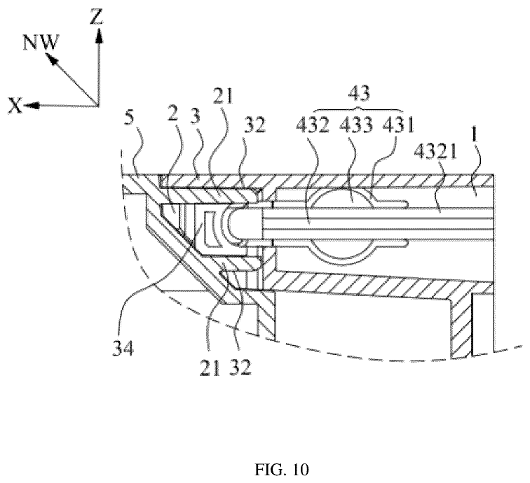

As shown in FIG. 9 and FIG. 10, FIG. 9 is a sectional view of the mounting structure according to some embodiments of the present disclosure, where the mounting bracket 1 of the mounting structure is located at a pre-mounting position of the second position; and FIG. 10 is a partial schematic sectional view of the mounting structure in the second position as shown in FIG. 2. In some embodiments, the insertion plate 21 may be directly inserted into and connected to the second slot 32 through the second opening 321, thereby being connected to the mounting bracket 1 in the second position.

As shown in FIG. 4, in some embodiments, the number of the first slot 31 may be two. As shown in FIG. 6, in some embodiments, the number of the second slots 32 may be two. As shown in FIG. 8 and FIG. 10, the number of the insertion plate 21 may be two.

As shown in FIG. 5, in some embodiments, a reinforcing plate 22 may be fixedly connected between the two insertion plates 21, and the reinforcing plate 22 and the two insertion plates 21 may form a hollow structure.

As shown in FIGS. 4-6, in some embodiments, two hollow structures may be formed in the first mounting portion 2. That is, four insertion plates 21 may be disposed in the first mounting portion 2, and every two insertion plates 21 may form one hollow structure through one reinforcing plate 22. The hollow structure may have a substantially C-shaped structure. The four insertion plates 21 may form a substantially double-C-shaped skeleton structure, in which the two C-shaped structures face away from each other. Correspondingly, four first slots 31 and four second slots 32 may be defined on the second mounting portion 3. Taking the first slots 31 as an example, among the four first slots 31, two pairs may be disposed on two sides of the second mounting portion 3, respectively. The two first slots 31 on one side may be directly inserted into and connected to one hollow structure, and the two first slots 31 on the other side may be directly inserted into and connected to the other hollow structure. With such arrangement, in a case where the first mounting portion 2 and the second mounting portion 3 are connected to each other through the direct insertion, multiple direct insertion connections may be simultaneously formed, enabling the connection to be stable and reliable.

As shown in FIGS. 4-6, a third direction may be a NW direction in the figures. In some embodiments, a first guiding bevel 23 may be formed on the first mounting portion 2 along the third direction. The first guiding bevel 23 may be connected to the insertion plate 21. A second guiding bevel 33 may be correspondingly formed on one side of the protrusion 34 along the third direction. The first guiding bevel 23 and the second guiding bevel 33 may be inclined along the third direction. Included angles may be formed between the third direction and the first direction and between the third direction and the second direction. In a case where the first mounting portion 2 and the second mounting portion 3 are connected to each other through the direct insertion, the first guiding bevel 23 and the second guiding bevel 33 may abut against each other.

In some embodiments, in a case where the first direction is substantially perpendicular to the second direction, the third direction may be located between the first direction and the second direction, the included angle between the third direction and the first direction may be substantially 45 degrees, and the included angle between the third direction and the second direction may be substantially 45 degrees. Inclination angles of the first guiding bevel 23 and the second guiding bevel 33 may both be substantially 45 degrees, which provides an auxiliary support when the first mounting portion 2 and the second mounting portion 3 are connected to each other through the direct insertion, so that the connection is stable.

As shown in FIG. 3, in some embodiments, the locking assembly 4 may include a clamping slot 41, a buckle 42, and an elastic structure 43. The clamping slot 41 may be defined on the first mounting portion 2. The first mounting portion 2 may be in the shape of a mounting slot. The substantially double-C-shaped skeleton structure formed by the insertion plates 21 may be fixed inside the mounting slot. The clamping slot 41 may be defined on an inner wall of the mounting slot. The buckle 42 may be disposed on the second mounting portion 3. The elastic structure 43 may be disposed on the second mounting portion 3 and connected to the buckle 42. In a case where the mounting bracket 1 is located at the first position or the second position, the elastic structure 43 may be configured to provide an elastic force for the buckle 42 to be clamped into the clamping slot 41. In some embodiments, an inclined guiding surface 421 may be formed on the buckle 42 (see FIG. 4) and may be pushed into the clamping slot 41 with a slight force. The buckle 42 may be buckled by the clamping slot 41 to achieve locking, which reduces the need for a traditional screw-locking structure and is easy to install.

As shown in FIG. 6, in some embodiments, the elastic structure 43 may include a pressing groove 431 and an elastic arm 432. The pressing groove 431 may be defined on the second mounting portion 3. The pressing groove 431 may substantially have a strip-shaped structure extending along the second direction. The elastic arm 432 may be disposed inside the pressing groove 431. One end of the elastic arm 432 may be fixedly connected to the pressing groove 431, and another end of the elastic arm 432 may be fixedly connected to the buckle 42. The buckle 42 may be fixed on an outer side of the elastic arm 432 and may be configured to cooperate with the clamping slot 41. The elastic arm 432 may be configured to be subjected to an external force to drive the buckle 42 to overcome the elastic force and disengage from the clamping slot 41, thereby achieving unlocking.

In some embodiments, a pressing plate 433 may be disposed on the elastic arm 432. The pressing plate 433 may be configured to provide a desirable point of application for pressing the elastic arm 432. The pressing plate 433 may be substantially disc-shaped, making it easy to press. The pressing plate 433 may be marked with a label “PUSH” to make the pressing plate 433 noticeable and to provide guidance for users during self-installation, enabling disassembly and assembly to be convenient.

It may be understood that the elastic structure 43 may adopt another elastic member, such as a spring and the like, as long as an elastic force may be provided for the buckle 42 to be clamped into the clamping slot 41. By pressing, the elastic arm 432 may be configured to drive the buckle 42 to disengage from the clamping slot 41. In a case where the pressing disappears, the elastic arm 432 may be configured to return to its original position under the elastic force of the elastic structure 43, thereby achieving a quick-locking and quick-unlocking function of the locking assembly 4 without requiring a bolt or another auxiliary tool, enabling one-button assembly and disassembly.

As shown in FIG. 3, in some embodiments, the number of the locking assembly 4 may be two and the two sets of locking assemblies 4 may be disposed on two sides. The elastic structures 43 may be disposed on the two sides of the mounting bracket 1. In a case where the user performs assembly or disassembly, the user may simply pinch both sides with the thumb and index finger to synchronously trigger the elastic structures 43 and perform unlock or lock through the elastic structures 43 simultaneously. The elastic structures 43 may be configured to drive the buckles 42 to extend to an outer wall of the second mounting portion 3, making the structure compact. As shown in FIG. 3 and FIG. 5, in each hollow structure formed by two insertion plates 21 and one reinforcing plate 22, a notch 211 may be defined to reserve a deformation space for the elastic structures 43, providing a relief space.

As shown in FIG. 7, in some embodiments, a reinforcing rib 4321 may be disposed on a side of the elastic arm 432 close to the first slot 31 or the second slot 32. The reinforcing rib 4321 may be fixedly connected to the elastic arm 432 and the mounting bracket 1, respectively, thereby enhancing the connection strength and service life of the elastic arm 432, reducing breakage caused by frequent use of the elastic arm 432, and ensuring the locking reliability of the locking assembly 4.

As shown in FIG. 1 and FIG. 2, some embodiments of the present disclosure provide a pan-tilt camera, including a housing 5 and the mounting structure described above. The housing 5 may be configured in the pan-tilt camera. The mounting structure may be connected to the housing 5 through the first mounting portion 2. The first direction may be substantially perpendicular to the second direction.

The above pan-tilt camera may include the mounting structure, and the first mounting portion 2 and the second mounting portion 3 may be connected to each other through the direct insertion, which provides a guiding installation function and allows for a relatively low requirement for machining accuracy and installation accuracy. In further combination with the locking assembly 4, the pan-tilt camera may achieve different installation manners through the mounting structure. The pan-tilt camera may have a simple structure, and allow for reduced cost and easy installation. In a case where the first direction and the second direction are substantially perpendicular to each other, the installation manner of the pan-tilt camera may be switched between the wall-mount manner and ceiling-mount manner, facilitating flexible installation and use for users.

The technical features of the embodiments described above may be arbitrarily combined. For simplicity of description, all possible combinations of the technical features in the above embodiments are not described. However, as long as the combinations of these technical features do not conflict, they shall all be considered within the scope described in this specification.

The embodiments described above merely illustrate several embodiments of the present disclosure and are described in a relatively concrete and detailed manner. However, they shall not be interpreted as limiting the scope of the present disclosure. It should be noted that, for those of ordinary skill in the art, without departing from the concept of the present disclosure, various modifications and improvements may be made, which shall fall within the protection scope of the present disclosure. Therefore, the protection scope of the present disclosure shall be subject to the appended claims.

1. A mounting structure, configured in a pan-tilt camera, and comprising:
a first mounting portion, disposed on the pan-tilt camera;
a mounting bracket, detachably connected to the first mounting portion at a first position or a second position;
wherein the mounting bracket comprises a second mounting portion and a mounting end;
in a case where the mounting bracket is located at the first position, the second mounting portion is connected to the first mounting portion through a direct insertion, and the mounting end is located at an end of the pan-tilt camera along a first direction; and
in a case where the mounting bracket is located at the second position, the second mounting portion is connected to the first mounting portion through the direct insertion, the mounting end is located at an end of the pan-tilt camera along a second direction, and an included angle is formed between the first direction and the second direction; and
a locking assembly, disposed between the mounting bracket and the first mounting portion, wherein the locking assembly is configured to lock and fix the first mounting portion to the mounting bracket.

2. The mounting structure as claimed in claim 1, wherein a protrusion is disposed at an end of the second mounting portion close to the first mounting portion, a first slot is defined on the protrusion, a first opening is defined at an end of the first slot, a second slot is defined on the protrusion, and a second opening is defined at an end of the second slot;
an insertion plate is disposed at the first mounting portion;
in a case where the mounting bracket is located at the first position, the insertion plate is directly inserted into and connected to the first slot through the first opening along the second direction, for being connected to the mounting bracket at the first position; and
in a case where the mounting bracket is located at the second position, the insertion plate is directly inserted into and connected to the second slot through the second opening along the second direction, for being connected to the mounting bracket at the second position.

3. The mounting structure as claimed in claim 2, wherein a first guiding bevel is formed on the first mounting portion along a third direction, the first guiding bevel is connected to the insertion plate, a second guiding bevel is correspondingly formed on a side of the protrusion along the third direction, the first guiding bevel and the second guiding bevel are inclined along the third direction, and included angles are formed between the third direction and the first direction and between the third direction and the second direction;
wherein in a case where the first mounting portion and the second mounting portion are connected to each other through the direct insertion, the first guiding bevel and the second guiding bevel abut against each other.

4. The mounting structure as claimed in claim 3, wherein inclination angles of the first guiding bevel and the second guiding bevel are both substantially 45 degrees.

5. The mounting structure as claimed in claim 3, wherein at least one of the following is satisfied: the number of the first slot is two, or the number of the second slot is two; and
the number of the insertion plate is two.

6. The mounting structure as claimed in claim 5, wherein a reinforcing plate is fixedly connected between the two insertion plates, and the reinforcing plate and the two insertion plates form a hollow structure.

7. The mounting structure as claimed in claim 1, wherein the locking assembly comprises:
a clamping slot, defined on the first mounting portion;
a buckle, disposed on the second mounting portion; and
an elastic structure, disposed on the second mounting portion and connected to the buckle, wherein in a case where the mounting bracket is located at the first position or the second position, the elastic structure is configured to provide an elastic force for the buckle to be clamped into the clamping slot.

8. The mounting structure as claimed in claim 7, wherein the elastic structure comprises:
a pressing groove, defined on the second mounting portion; and
an elastic arm, disposed inside the pressing groove, wherein an end of the elastic arm is fixedly connected to the pressing groove, and another end of the elastic arm is fixedly connected to the buckle;
wherein the elastic arm is configured to be subjected to an external force to drive the buckle to overcome the elastic force and disengage from the clamping slot, for achieving unlocking.

9. The mounting structure as claimed in claim 8, wherein a pressing plate is disposed on the elastic arm.

10. The mounting structure as claimed in claim 8, wherein a reinforcing rib is disposed on a side of the elastic arm close to the first slot or the second slot.

11. A pan-tilt camera, comprising a housing and a mounting structure, wherein the mounting structure comprises:
a first mounting portion, disposed on the pan-tilt camera;
a mounting bracket, detachably connected to the first mounting portion at a first position or a second position;
wherein the mounting bracket comprises a second mounting portion and a mounting end;
in a case where the mounting bracket is located at the first position, the second mounting portion is connected to the first mounting portion through a direct insertion, and the mounting end is located at an end of the pan-tilt camera along a first direction; and
in a case where the mounting bracket is located at the second position, the second mounting portion is connected to the first mounting portion through the direct insertion, the mounting end is located at an end of the pan-tilt camera along a second direction, and an included angle is formed between the first direction and the second direction; and
a locking assembly, disposed between the mounting bracket and the first mounting portion, the locking assembly is configured to lock and fix the first mounting portion to the mounting bracket;
wherein the mounting structure is connected to the housing through the first mounting portion, and the first direction is substantially perpendicular to the second direction.

12. The pan-tilt camera as claimed in claim 11, wherein a protrusion is disposed at an end of the second mounting portion close to the first mounting portion, a first slot is defined on the protrusion, a first opening is defined at an end of the first slot, a second slot is defined on the protrusion, and a second opening is defined at an end of the second slot;
an insertion plate is disposed at the first mounting portion;
in a case where the mounting bracket is located at the first position, the insertion plate is directly inserted into and connected to the first slot through the first opening along the second direction, for being connected to the mounting bracket at the first position; and
in a case where the mounting bracket is located at the second position, the insertion plate is directly inserted into and connected to the second slot through the second opening along the second direction, for being connected to the mounting bracket at the second position.

13. The pan-tilt camera as claimed in claim 12, wherein a first guiding bevel is formed on the first mounting portion along a third direction, the first guiding bevel is connected to the insertion plate, a second guiding bevel is correspondingly formed on a side of the protrusion along the third direction, the first guiding bevel and the second guiding bevel are inclined along the third direction, and included angles are formed between the third direction and the first direction and between the third direction and the second direction;
wherein in a case where the first mounting portion and the second mounting portion are connected to each other through the direct insertion, the first guiding bevel and the second guiding bevel abut against each other.

14. The pan-tilt camera as claimed in claim 13, wherein inclination angles of the first guiding bevel and the second guiding bevel are both substantially 45 degrees.

15. The pan-tilt camera as claimed in claim 13, wherein the number of at least one of the first slot or the second slot is two;
the number of the insertion plate is two.

16. The pan-tilt camera as claimed in claim 15, wherein a reinforcing plate is fixedly connected between the two insertion plates, and the reinforcing plate and the two insertion plates form a hollow structure.

17. The pan-tilt camera as claimed in claim 11, wherein the locking assembly comprises:
a clamping slot, defined on the first mounting portion;
a buckle, disposed on the second mounting portion; and
an elastic structure, disposed on the second mounting portion and connected to the buckle, wherein in a case where the mounting bracket is located at the first position or the second position, the elastic structure is configured to provide an elastic force for the buckle to be clamped into the clamping slot.

18. The pan-tilt camera as claimed in claim 17, wherein the elastic structure comprises:
a pressing groove, defined on the second mounting portion; and
an elastic arm, disposed inside the pressing groove, wherein an end of the elastic arm is fixedly connected to the pressing groove, and another end of the elastic arm is fixedly connected to the buckle;
wherein the elastic arm is configured to be subjected to an external force to drive the buckle to overcome the elastic force and disengage from the clamping slot, for achieving unlocking.

19. The pan-tilt camera as claimed in claim 18, wherein a pressing plate is disposed on the elastic arm.

20. The pan-tilt camera as claimed in claim 18, wherein a reinforcing rib is disposed on a side of the elastic arm close to the first slot or the second slot.
